(19) United States
(12) Patent Application Publication
(10) Pub. No.: US 2007/0123306 A1
(43) Pub. Date: May 31, 2007

(54) Method for stabilizing bts using e1 trunk board duplexing of bsc

(76) Inventor: Se Yeon Kim, Seoul (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/545,922

(22) PCT Filed: Mar. 24, 2004
(86) PCT No.: PCT/KR04/00645

§ 371 Date: Oct. 30, 2006

(30) Foreign Application Priority Data
Mar. 25, 2003 (KR) 10-2003-0018549

(51) Int. Cl. H04B 1/38

(52) U.S. Cl. 455/561

(57) ABSTRACT

A method for stabilizing a BTS by dualizing an E1 trunk board in a BSC, wherein the method operates the E1 trunk board in a dual mode by establishing at least two E1 interfacing connections between the BTS and the BSC. This is so that the BTS continues to provide a service through an available E1 link even though one of the E1 interfacing connections is disabled, thereby improving the maintenance capability of a communication system. The method comprises the steps of determining whether a pair of HNEA-A2 boards are mounted or demounted; checking a next board where the pair of HNEA-A2 boards are demounted and determining whether the pair of HNEA-A2 boards are mounted on upper and lower shelves; setting an identical address to the pair of HNEA-A2 boards where the pair of HNEA-A2 boards are mounted on the upper and lower shelves and checking status of the pair of HNEA-A2 boards mounted on the upper and lower shelves; communicating data with the BTS where the pair of HNEA-A2 boards are normal and checking whether all of the pair of HNEA-A2 boards are abnormal; interrupting a service of the BTS when all of the pair of HNEA-A2 boards are abnormal and communicating data with the BTS through a board out of the pair of HNEA-A2 boards where the board is normal; setting an address to one of the HNEA-A2 boards where the addressed board is mounted on the upper or lower shelf; checking whether the addressed board is normal; and communicating data with the BTS through the addressed board where the addressed board is normal and interrupting a service of the BTS where the addressed board is abnormal.

### TECHNICAL FIELD

The present invention generally relates to methods for maintaining communications systems, and particularly to a method for stabilizing a base station transceiver subsystem (BTS) by dualizing a European digital transmission (E1) trunk board in a base station controller (USC). More particularly, the method operates the E1 trunk board in a dual mode by establishing at least two E1 interfacing connections between the BTS and the BSC. This is so that the BTS may continue to provide service through an available E1 link even though one of the E1 interfacing connections is disabled, thereby improving the maintenance capability of a communication system.

### BACKGROUND ART

In a conventional wireless local loop (WLL) system, communication connections between a base station controller (BSC) and a base station transceiver subsystem (BTS) are established through an E1 trunk interfacing board. Although boards used for communication connections in the WLL system typically operate in a dual mode, the E1 trunk interfacing board operates in a single mode. This tends to interrupt the BTS service if nodes fail or cables become disconnected in the BTS.

FIG. 1 shows a schematic block diagram of a prior art WLL system. FIG. 2 shows a block diagram of a prior art local CDMA intercommunication network (LCIN) block. As shown in FIG. 1, the communication connections between a BSC 10 and a BTS 20 are established through the E1/T1 interfaces.

BSC 10 comprises a call control processor (CCP) block 11, an alarm control processor (ACP) block 12, a transcoder and selector bank (TSB) block 13 and an LCIN block 14. CCP block 11 controls the entire operation of BSC 10. ACP block 12 collects the alarms of BSC 10. TSB block 13 performs a resource assignment function and a processing function. LCIN block 14 provides paths of packets and performs a routing function.

BTS 20 comprises a plurality of boards, BTS manager processor (BMP) blocks 21 and radio frequency (RF) blocks 22. The boards communicate with BSC 10 through the E1/T1 interfaces. Each BMP block 21 comprises a channel card configured to perform a channel assignment and a processing function. They further each comprise a board which is operative to convert an analog signal to a digital signal and vice versa. RF blocks 22 process the radio signals.

Referring now to FIG. 2, LCIN block 14 comprises three types of boards: (1) two high-speed interconnection control board assembly A2 (HICA-A2) boards; (2) a plurality of high-speed routing node board assembly A2 (HRNA-A2) boards; and (3) a number of high-speed capacity node and E1 assembly A2 (HNEA-A2) boards. Each HICA-A2 board is a processor board used for managing LCIN block 14. Each HRNA-A2 board routes the signals in BSC 10. Each HNEA-A2 board communicates with BTS 20 through the E1 interface.

More specifically, the two HICA-A2 boards manage the entire LCIN block 14. The HRNA-A2 boards route the signals inputted from BTS 20 and BSC 10. The HNEA-A2 boards communicate with BTS 20 through the E1 interface. The two HICA-A2 boards operate in a dual mode, one of which operates in an active state while the other operates in a standby state. If the HICA-A2 board operating in the active state fails, then the other board switches from the standby state to the active state. Subsequently, the HICA-A2 board in the active state is switched to the standby state.

Each HICA-A2 board periodically checks the status of the HRNA-A2 boards, HNEA-A2 boards, nodes and lines within LCIN block 14. The HICA-A2 boards then report them to CCP block 11 and a base station manager (BSM) 40 that are upper level in the hierarchy. Each HRNA-A2 board has eight nodes, each of which is connected to the boards of other blocks in BSC 10. As mentioned before, each HRNA-A2 board routes packets in LCIN block 14. Similar to HRNA-A2 boards, each HNEA-A2 board has eight nodes and can afford eight E1 interfaces.

LCIN block 4 occupies two shelves. The two shelves are arranged in an up and down relationship and operate in a dual mode. However, the HNEA-A2 boards operate in a single mode rather than a dual mode. More particularly, the HICA-A2 boards operate in the active and standby states and the HRNA-A2 boards are connected to the boards of other blocks in BSC 10.

In a pair of HRNA-A2 boards facing each other in an up and down relationship, one set of eight nodes corresponds to another set of eight nodes. For instance, a second node of an upper HRNA-A2 board and a second node of a lower HRNA-A2 board are connected to the same block (e.g., CCP block 11) and assigned to an identical address so that data is transmitted to the pair of HRNA-A2 boards. In such mode, a communication link between the blocks and the HRNA-A2 boards is maintained even though one of the HRNA-A2 boards is demounted or a cable becomes disconnected.

However, the HNEA-A2 boards operate in a single mode. E1 such mode, a service of BTS 20 may be interrupted when the HNEA-A2 boards on BSC 10 are demounted, a node connected to BTS 20 fails or a cable becomes disconnected. Particularly, an E1 interfacing board employed in BSC 10 interfaces with an E1 link of BTS 20 in a single mode.

If BTS 20 is a MARO base station, then a plurality of E1 links may be provided. On the other hand, if BTS 20 is a Pico or Micro base station, then one or two E1 links may be provided. However, a service of the Pico or Micro base station may become interrupted when the boards connected to BSC 10 are demounted, a node suffers a failure or a cable becomes disconnected.

### DISCLOSURE OF THE INVENTION

It is, therefore, an objective of the present invention to provide a method for stabilizing a base station transceiver subsystem (BTS) by dualizing a European digital transmission (E1) trunk board in a base station controller (BSC). More particularly, the method operates the E1 trunk board in a dual mode by establishing at least two E1 interfacing connections between the BTS and the BSC. This is so that the BTS continues to provide a service through an available E1 link even though one of the E1 interfacing connections is disabled, thereby improving the maintenance capability of a communication system.

In accordance with the present invention, there is provided a method for stabilizing a base station transceiver subsystem (BTS) by dualizing a European digital transmission (E1) trunk board in a base station controller (BSC), comprising the steps of: determining whether a pair of high speed capacity node and E1 assembly A2 (HNEA-A2) boards are mounted or demounted after checking a status of the pair of HNEA-A2 boards, wherein the HNEA-A2 boards are arranged in an up and down relationship; checking a next board in case the pair of HNEA-A2 boards are demounted and determining whether the pair of HNEA-A2 boards are mounted on upper and lower shelves; setting an identical address to the HNEA-A2 boards in case they are mounted on the upper and lower shelves and checking the status of the HNEA-A2 boards mounted on the upper and lower shelves; communicating data with the BTS in case the HNEA-A2 boards are normal and checking whether all of the HNEA-A2 boards are abnormal in which the checked results represent abnormal states; interrupting a service of the BTS in case all of the HNEA-A2 boards are abnormal and communicating data with the BTS through one of the HNEA-A2 boards when it is normal; setting an address to one of the HNEA-A2 boards in case the addressed board is mounted on the upper or lower shelf; checking whether the addressed board is normal; and communicating data with the BTS through the addressed board in case the addressed board is normal and interrupting a service of the BTS in case the addressed board is abnormal.

The foregoing and other objects and features of the present invention will become more fully apparent from the following description, appended claims and their accompanying drawings.

### BRIEF DESCRIPTION OF DRAWINGS

These drawings depict only the preferred embodiments of the present invention and should not be considered as limitations of its scope. These as well as other features of the present invention will become more apparent upon reference to the drawings in which:

FIG. 1 illustrates a schematic block diagram of a conventional wireless local loop (WLL) system.

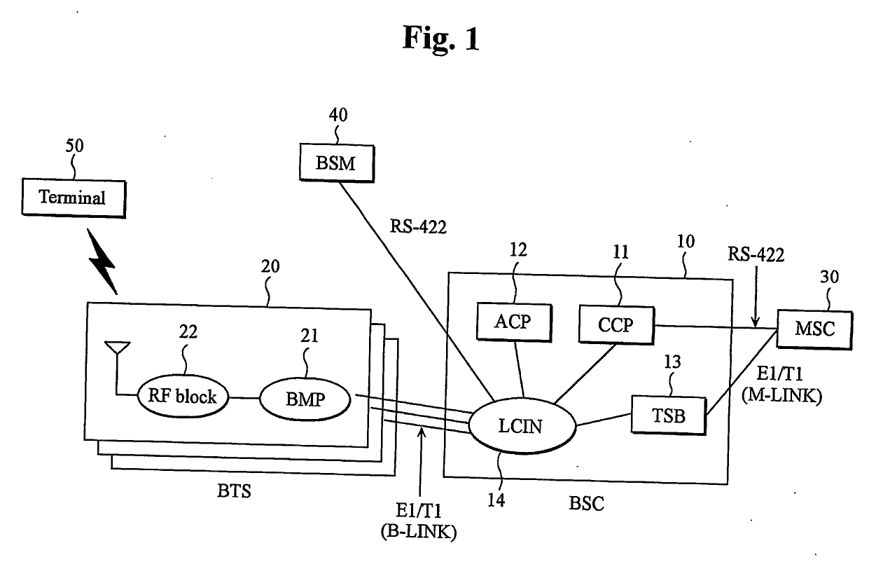

FIG. 2 illustrates a block diagram of a conventional local CDMA intercommunication network (LCIN) block.

FIG. 3 illustrates a diagram of shelves for mounting hardware for embodying a LCIN block and a link diagram of a high-speed capacity node and E1 assembly A2 (HNEA-A2) board in accordance with the present invention.

FIG. 4 illustrates a diagram of a structure interfacing with a base station transceiver subsystem (ITS) in single and dual modes in accordance with the present invention.

FIG. 5 illustrates a flow chart representing an operation of the pair of HNEA-A2 boards in the dual mode in accordance with the present invention.

### BEST MODE FOR CARRYING OUT THE INVENTION

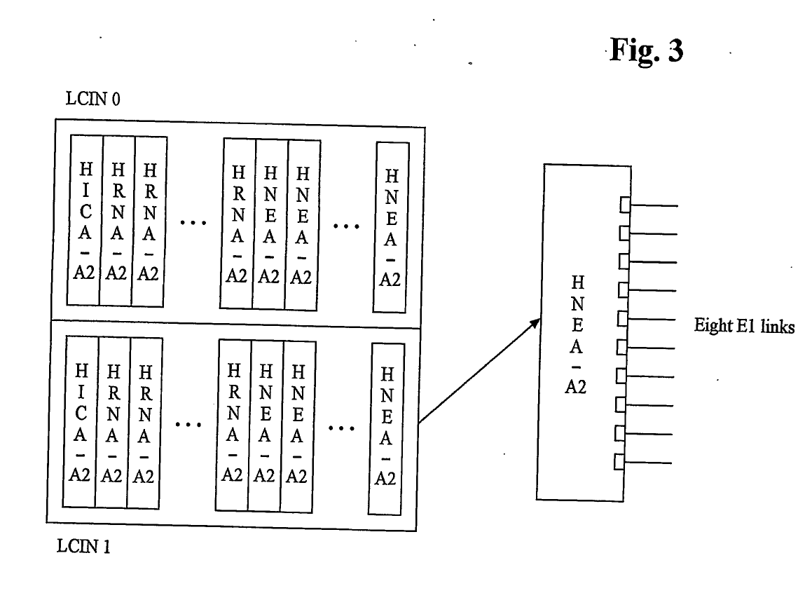

It will be readily understood that the components and steps of the present invention, as generally described and illustrated herein and in the accompanying Figures, may be arranged and designed in a wide variety of different configurations while still utilizing the inventive concept of the present invention. Thus, the detailed description of the preferred embodiments of the present invention, as described and illustrated herein and in FIGS. 3-5, is not intended to limit the scope of the present invention. It is merely representative of the preferred embodiments of the present invention. The preferred embodiments of the present invention will be best understood by reference to the Figures, wherein certain parts or steps described herein are designated by their corresponding numerals throughout the Figures.

In accordance with the present invention, a pair of HNEA-A2 boards operates in a dual mode similar to a pair of HRNA-A2 boards. This is so that a service of the BTS can be maintained even though boards are demounted, nodes suffer a failure, or cables become disconnected.

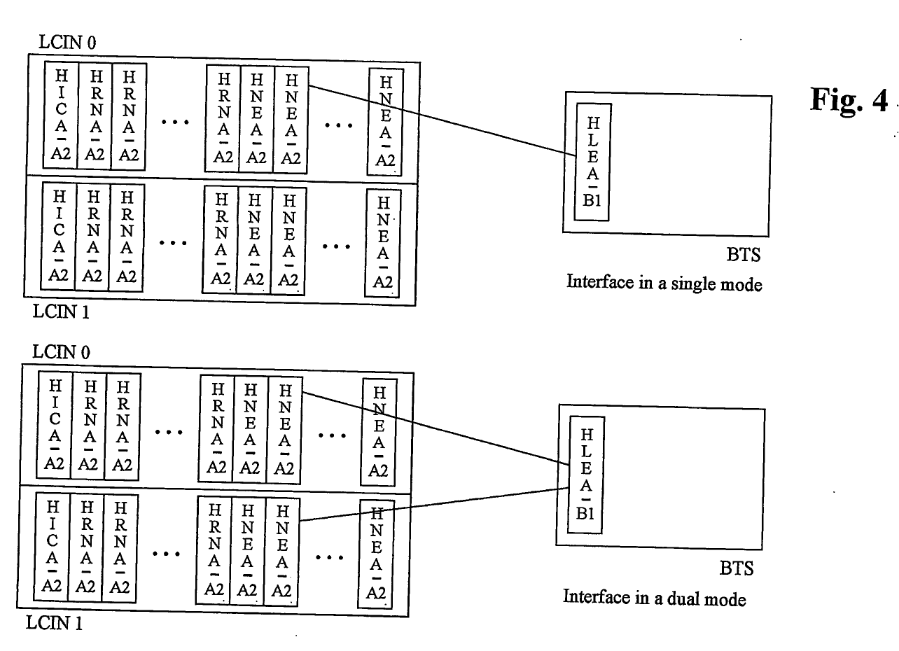

FIG. 3 shows a diagram of shelves for mounting hardware for embodying an LCIN block and a link diagram of HNEA-A2 boards in accordance with the present invention. FIG. 4 shows a diagram of a structure interfacing with the BTS in single and dual modes in accordance with the present invention.

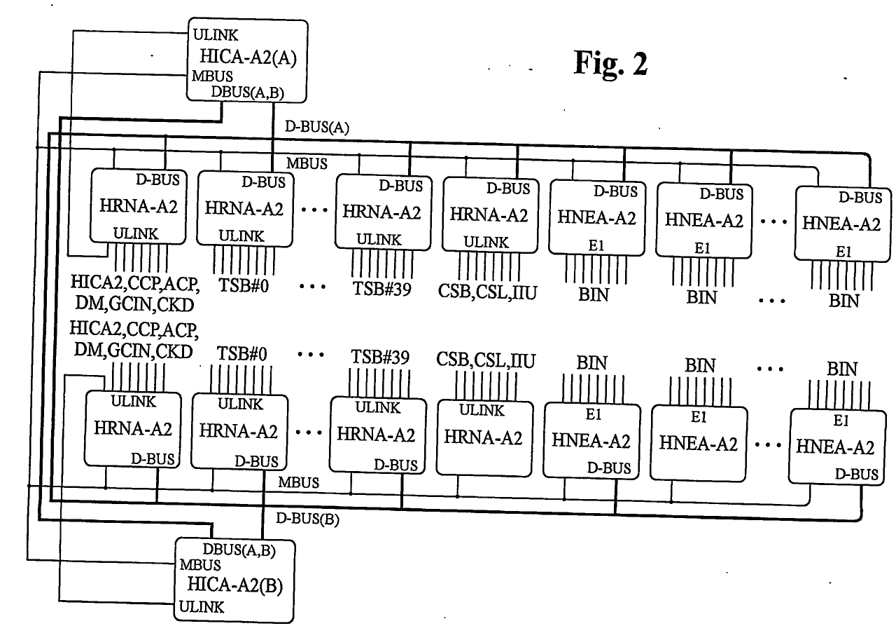

As described with reference to FIG. 2, LCIN block 14 occupies two shelves that are arranged in an up and down relationship and operate in a dual mode. In contrast to the HICA-A2 boards and the HRNA-A2 boards, the pair of HNEA-A2 boards operate in a single mode rather than a dual mode. That is, the HICA-A2 boards operate in active and standby states and HRNA-A2 boards are connected to the boards of other blocks in BSC 10. In a pair of HRNA-A2 boards facing each other in an up and down relationship, one set of eight nodes corresponds to another set of eight nodes. Since the pair of HNEA-A2 boards operates in a single mode, a service of BTS 20 may become interrupted when the pair of HNEA-A2 boards on BSC 10 are demounted, nodes connected to BTS 20 fail or a cable becomes disconnected.

To solve the foregoing deficiencies, the present invention operates the pair of HNEA-A2 boards facing each other in an up and down relationship in a dual mode.

This enables a service of a BTS even though the pair of HNEA-A2 boards are demounted, nodes suffer a failure or cables become disconnected.

As mentioned before, FIG. 3 shows a diagram of shelves for mounting hardware for embodying an LCIN block (not shown) and a link diagram of HNEA-A2 boards in accordance with the present invention. Further, a structure of the LCIN block is identical to that of LCIN block 14 shown in FIG. 2. Each HNEA-A2 board is comprised of eights E1 links that establish communication connections to the BTS. As for FIG. 4, there is shown a diagram of a structure interfacing with the BTS in single and dual modes in accordance with the present invention.

Descriptions for operating a pair of HNEA-A2 boards in a dual mode are as follows. First, one of the two HICA-A2 boards periodically checks the status of the HNEA-A2 boards. Specifically, the HICA-A2 board determines whether the HNEA-A2 boards are mounted or demounted after checking the status of the same. The HICA-A2 board then checks the next board where the pair of HNEA-A2 boards are demounted. However, if the HNEA-A2 boards are mounted, then the HICA-A2 board determines whether they are mounted on the upper and lower shelves. Thereafter, the HICA-A2 sets an identical address to the HNEA-A2 boards where they are mounted on the upper and lower shelves, respectively.

Subsequently, the HICA-A2 checks the status of the pair of HNEA-A2 boards and communicates data with the BTS where the pair of HNEA-A2 boards is normal. The HICA-A2 checks whether all of the pair of HNEA-A2 boards are abnormal in which case the checked results represent abnormal states. The HICA-A2 interrupts a service of the BTS where all of the pair of HNEA-A2 boards are abnormal. The HICA-A2 then communicates data with the BTS through one of the HNEA-A2 boards where the board is normal.

The HICA-A2 sets an address to one of the HNEA-A2 boards where it is mounted on the upper or lower shelf. The HICA-A2 checks whether the addressed board is normal and communicates data with the BTS through the addressed board when it is normal. However, if the addressed board is abnormal, then the HICA-A2 interrupts the service of the BTS.

Further, where cables are disconnected or nodes suffer a failure, the mentioned inventive process may be applicable.

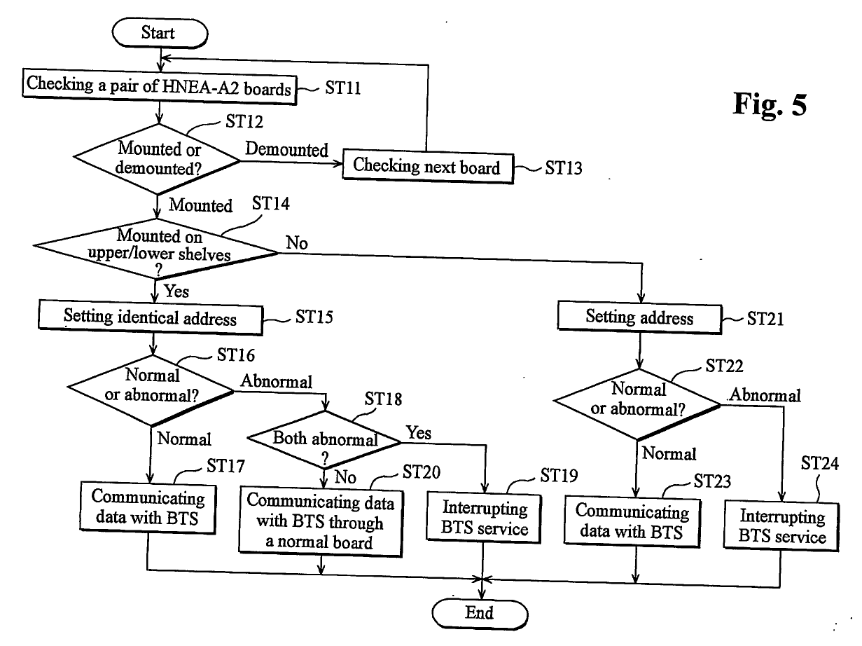

In view of FIG. 5, the inventive process can now be described in detail. As shown in FIG. 5, there is shown a flow chart depicting an operation of the pair of HNEA-A2 boards in the dual mode in accordance with the present invention.

At step ST11, the process checks the status of the HNEA-A2 boards that are arranged in an up and down relationship. At step ST12, the process determines whether the pair of HNEA-A2 boards are mounted or demounted. At step ST13, the process checks the next board where the HNEA-A2 boards are demounted. At step ST14, the process determines whether the HNEA-A2 boards are mounted on the upper and lower shelves. At step ST15, the process sets an identical address to the HNEA-A2 boards where they are mounted on the upper and lower shelves. At step ST16, the process checks the status of the HNEA-A2 boards mounted on the shelves.

At step ST17, the process communicates data with the BTS where the pair of HNEA-A2 boards are normal.

Furthermore, at step ST18, the process checks whether all the HNEA-A2 boards are abnormal in which the checked results represent abnormal states. At step ST19, the process interrupts a service of the BTS when all the HNEA-A2 boards are abnormal. At step ST20, the process communicates data with the BTS through one of the HNEA-A2 boards when the board is normal. At step ST21, the process sets an address to one of the HNEA-A2 boards when the addressed board is mounted on the upper or lower shelf as in step ST14. At step ST22, the process checks whether the addressed board is normal. At step ST23, the process communicates data with the BTS through the addressed board when it is normal. At step ST23, the process interrupts the service of the BTS when the addressed board is abnormal.

More specifically, the HICA-A2 board determines whether the pair of HNEA-A2 boards, which are arranged in an up and down relationship, are mounted or demounted after checking their status. The HICA-A2 board checks the next board where the pair of HNEA-A2 boards are demounted. However, if the HNEA-A2 boards are mounted, then the HICA-A2 board determines whether they are mounted on the upper and lower shelves. Thereafter the HICA-A2 sets an identical address to the pair of HNEA-A2 boards where they are mounted on the upper and lower shelves.

Subsequently, the HICA-A2 checks the status of the HNEA-A2 boards and communicates data with the BTS when the HNEA-A2 boards are normal. The HICA-A2 checks whether all of the HNEA-A2 boards are abnormal in which the checked results represent abnormal states. Then, the HICA-A2 interrupts a service of the BTS when all of the pair of HNEA-A2 boards are abnormal and communicates data with the BTS through one of the HNEA-A2 boards when the board is normal.

The HICA-A2 sets an address to one of the HNEA-A2 boards when the addressed board is mounted on the upper or lower shelf. The HICA-A2 checks whether the addressed board is normal. It then communicates data with the BTS through the addressed board when it is normal. However, if the addressed board is abnormal, then the HICA-A2 interrupts the service of the BTS.

It is noted that at least two ports capable of connecting to an E1 interfacing board should be provided within an E1 trunk interfacing board of the BTS in order to apply the structure of the present invention to a commercially available system.

### INDUSTRIAL APPLICABILITY

In accordance with the present invention, a method for stabilizing a BTS by dualizing an E1 trunk board in a BSC is provided, wherein the method operates the E1 trunk board in a dual mode by establishing at least two E1 interfacing connections between a BTS and a BSC so that the BTS continues to provide a service through an available E1 link even though one of the E1 interfacing connections is disabled, thereby improving the maintenance capability of a communication system.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A method for stabilizing a base station transceiver subsystem (BTS) by dualizing a European digital transmission (E1) trunk board in a base station controller (BSC), comprising the steps of:
determining whether a pair of high speed capacity node and E1 assembly A2 (HNEA-A2) boards are mounted or demounted after checking a status of the pair of HNEA-A2 boards, wherein the pair of HNEA-A2 boards are arranged in an up and down relationship;
checking a next board in case the pair of HNEA-A2 boards are demounted and determining whether the pair of HNEA-A2 boards are mounted on upper and lower shelves;
setting an identical address to the pair of HNEA-A2 boards in case the pair of HNEA-A2 boards are mounted on the upper and lower shelves and checking the status of the pair of HNEA-A2 boards mounted on the upper and lower shelves;
communicating data with the BTS in case the pair of HNEA-A2 boards are normal and checking whether all of the pair of HNEA-A2 boards are abnormal in case the checked results represent abnormal states;
interrupting a service of the BTS in case all of the pair of HNEA-A2 boards are abnormal and communicating data with the BTS through a board out of the pair of HNEA-A2 boards in case the board is normal;
setting an address to one out of the pair of HNEA-A2 boards in case the addressed board is mounted on the upper or lower shelf;
checking whether the addressed board is normal; and
communicating data with the BTS through the addressed board in case the addressed board is normal and interrupting a service of the BTS in case the addressed board is abnormal.
